(19) United States
(12) Patent Application Publication
(10) Pub. No.: US 2010/0123546 A1
(43) Pub. Date: May 20, 2010

(54) ELECTRONIC APPARATUS AND REMOTE CONTROL METHOD OF THE SAME

(75) Inventors: Kyung-ho Seo, Yongin-si (KR); Jong-kil Sun, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/556,755

(22) Filed: Sep. 10, 2009

(30) Foreign Application Priority Data
Nov. 20, 2008 (KR) 10-2008-0115931

(51) Int. Cl. G06F 7/04

(52) U.S. Cl. 340/5.51; 340/5.2

(57) ABSTRACT

Disclosed is a remote control method of an electronic apparatus including a passive control device and a remote controller remotely controlling the passive control device, the remote control method including: outputting from the remote controller a control signal including an identification (ID) code and a data code; storing in the passive control device a control ID code corresponding to the ID code; comparing the ID code with the control ID code; and controlling the passive control device to operate based on the data code if the ID code is matched with the control ID code.

### CROSS-REFERENCE TO RELATED APPLICATION

This application claims priority from Korean Patent Application No. 10-2008-0115931, filed on Nov. 20, 2008 in the Korean Intellectual Property Office, the disclosure of which is incorporated herein by reference.

### BACKGROUND OF INVENTION

1. Field of Invention

Apparatuses and methods consistent with the present invention relate to an electronic apparatus and a remote control method of the same, and more particularly to an electronic apparatus and a remote control method of the same, in which if a plurality of the same kind of electronic apparatuses is provided, an error in remote control of each electronic apparatus is prevented.

2. Description of the Related Art

These days, most electronic apparatuses include a passive control device and a remote controller that remotely controls the passive control device. Further, it is possible to control a plurality of electronic apparatuses by a control signal output from the remote controller. Such apparatuses may be of the same kind or model, or may be different, but capable of being controlled as if they were the same kind or model (e.g., programmable to emulate a particular kind or model). As used herein, the phrase “same kind” or “same model” refers to any of the above-noted possibilities.

For example, if a fitness center, a hospital or the like uses a plurality of the same kind of electronic apparatuses, a plurality of passive control devices are uniformly controlled by a control signal from one remote controller. However, a problem exists if the user does not wish to control all of the plurality of passive control devices uniformly.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

According to an aspect of the present invention, there is provided a remote control method of an electronic apparatus including a passive control device and a remote controller remotely controlling the passive control device, the remote control method including: outputting from the remote controller a control signal including an identification (ID) code and a data code; storing in the passive control device a control ID code corresponding to the ID code; comparing the ID code with the control ID code; and controlling the passive control device to operate based on the data code if the ID code is matched with the control ID code.

The ID code may be user selectable.

The ID code may include an n-bit signal.

The remote control method may further include outputting the control ID code from the passive control device.

The passive control device may include a display unit, and the control ID code may be displayed on the display unit.

The passive control device may include a sound output unit, and the control ID code may be output through the sound output unit.

The remote control method may further include controlling the passive control device not to operate based on the data code if the ID code is not matched with the control ID code.

The remote control method may further include informing a user of the control ID code stored in the passive control device if the ID code is not matched with the control ID code.

The remote control method may further include releasing a setting of the control ID code if the passive control device is turned off.

According to another aspect of the present invention, there is provided an electronic apparatus including: a remote controller which includes an identification (ID) code generator to generate an ID code, and outputs a control signal including the ID code and a data code; and a passive control device which includes a code generator, a storage unit and a controller, wherein the code generator generates a control ID code corresponding to the ID code, wherein the storage unit stores the control ID code, and wherein the controller compares the ID code with the control ID code stored in the storage unit and controls the passive control device to operate based on the data code if the ID code is matched with the control ID code.

The remote controller may include a plurality of input buttons, and the ID code generator generates the ID code based on a combination of the plurality of input buttons.

The passive control device may further include a display unit, and the controller may control the display unit so that the control ID code can be displayed in the passive control device.

The passive control device may further include a sound output unit, and the controller may control the sound output unit so that the control ID code can be output in the passive control device.

The controller may compare the ID code with the control ID code stored in the storage unit and control the passive control device not to operate based on the data code if the ID code is not matched with the control ID code.

The controller may compare the ID code with the control ID code stored in the storage unit and control the display unit to display the control ID code stored in the passive control device if the ID code is not matched with the control ID code.

The controller may compare the ID code with the control ID code stored in the storage unit and control the sound output unit to output the control ID code stored in the passive control device if the ID code is not matched with the control ID code.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a control block diagram of an electronic apparatus according to an exemplary embodiment of the present invention;

FIG. 2 shows a control signal output from a remote controller of the electronic apparatus according to an exemplary embodiment of the present invention;

FIG. 3 shows interlock between the remote controller and a passive control device of the electronic apparatus according to an exemplary embodiment of the present invention;

FIG. 4 shows a remote control operation of the electronic apparatus according to an exemplary embodiment of the present invention;

FIG. 5 is a flowchart of remotely controlling the electronic apparatus according to an exemplary embodiment of the present invention;

FIG. 6 is a flowchart of remotely controlling the electronic apparatus according to a another exemplary embodiment of the present invention; and

FIG. 7 is a flowchart of remotely controlling the electronic apparatus according to a still another exemplary embodiment of the present invention.

### DETAILED DESCRIPTION OF EXEMPLARY EMBODIMENTS OF THE INVENTION

Below, an electronic apparatus and a remote control method of the same according to exemplary embodiments of the present invention will be described in detail with reference to accompanying drawings.

While some of the exemplary embodiments of the present invention are described to achieve one-to-one correspondence between a remote controller and a passive control device in a place where the same kind of electronic apparatuses are installed, the present invention is not limited thereto. For example, different kinds of electronic apparatuses might each be capable of being simultaneously controlled by the remote controller.

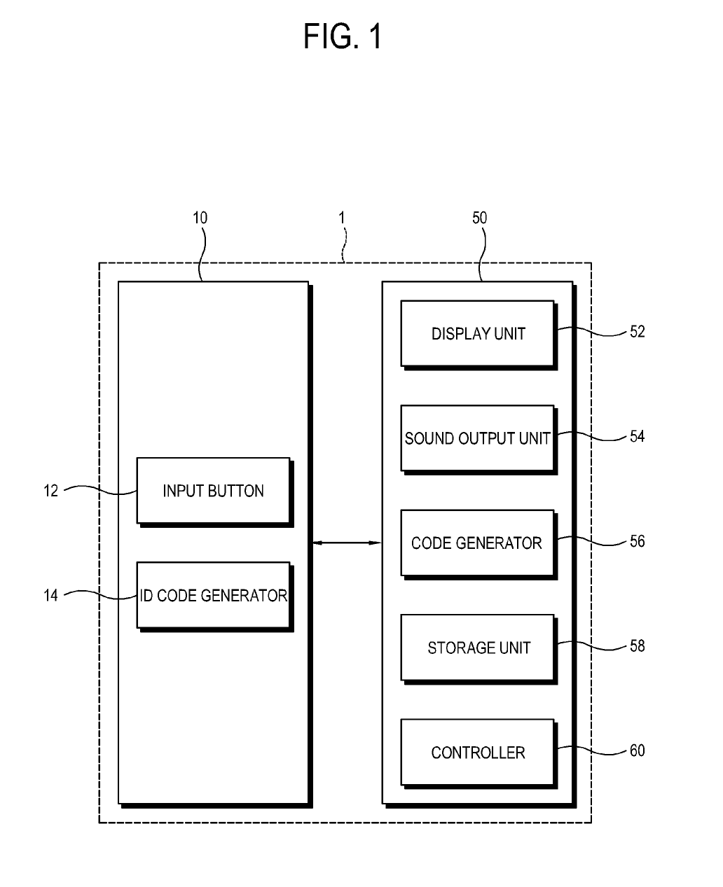

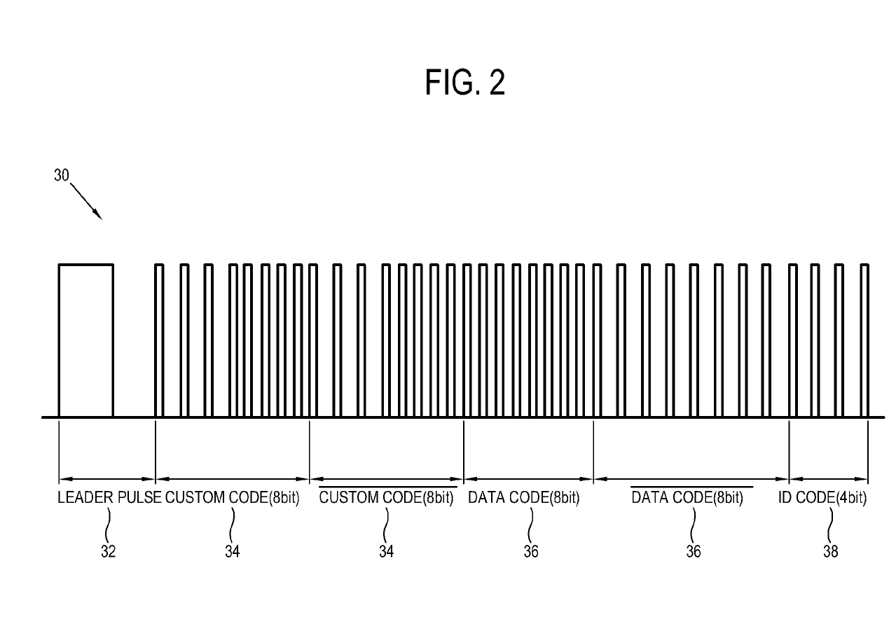

As shown in FIGS. 1 and 2, an electronic apparatus 1 according to an exemplary embodiment of the present invention includes a remote controller 10, and a passive control device 50 remotely controlled by the remote controller 10.

The remote controller 10 outputs a control signal 30 to control an operation of the passive control device 50. In this embodiment, the remote controller 10 includes an input button 12 to input the control signal 30, and an identification (ID) code generator 14 to generate an ID code 38.

The input button 12 is plurally arranged in the remote controller 10. For example, the input button 12 includes various buttons such as a power button, channel up/down buttons, volume up/down buttons and number buttons.

The ID code generator 14 generates the ID code 38 for allowing the remote controller 10 and the passive control device 50 to be paired. Here, the ID code generator 14 may generate the ID code 38 by a combination of various buttons provided as the input button 12. For example, the ID-code generator 14 may generate the ID code 38 by a combination of “channel up+number 1+number 2” of the input button 12, or may generate the ID code 38 by continuously inputting an arbitrary button of the input button 12. Also, the input button 12 may include an additional button for operating the ID code generator 14.

In general, the control signal 30 output from the remote controller 10 includes a leader pulse 32, a custom code 34 and a data code 36. In this embodiment, the remote controller 10 controls the ID code generator 14 to add the ID code 38 to the control signal 30.

The leader pulse 32 of the control signal 30 output from the remote controller 10 indicates input of an infrared (IR) signal. The custom code 34 is a signal containing a manufacturing company, the kind, a model number, etc. of the electronic apparatus 1. The command code 36 is a signal for controlling the passive control device 50, and the ID code 38 is a signal for one-to-one correspondence between the remote controller 10 and the passive control device 50.

The control signal generally includes a 32-bit signal. The general control signal includes two 8-bit custom codes 34 and two 8-bit data codes 36. On the other hand, according to an exemplary embodiment of the present invention, the control signal 30 output from the remote controller 10 is achieved by adding an n-bit ID code 38 to total 32-bit custom and data codes 34 and 36.

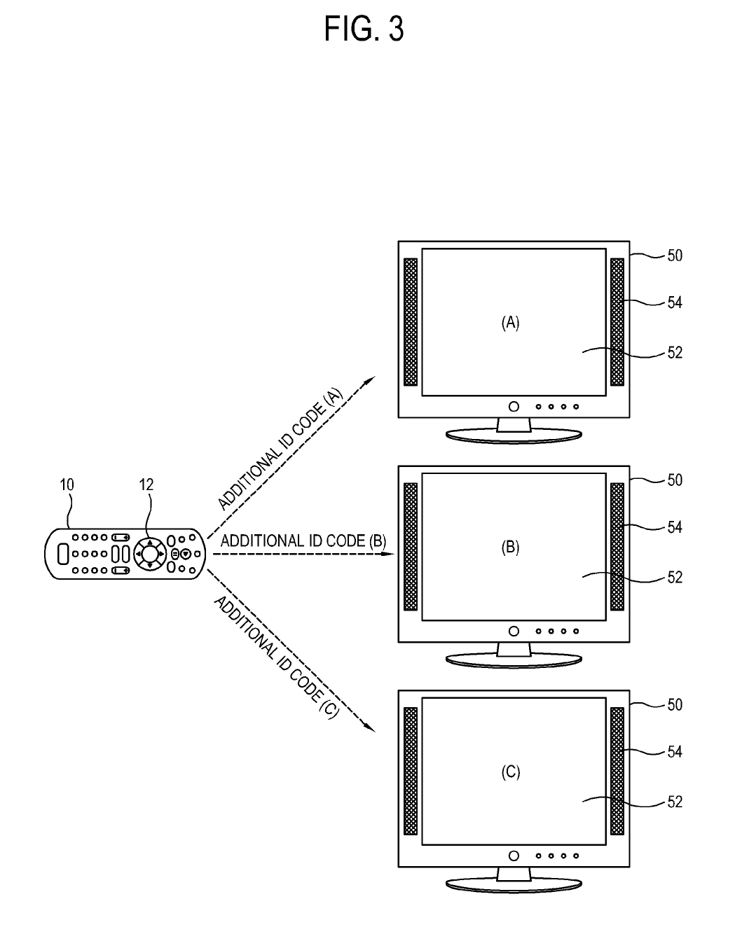

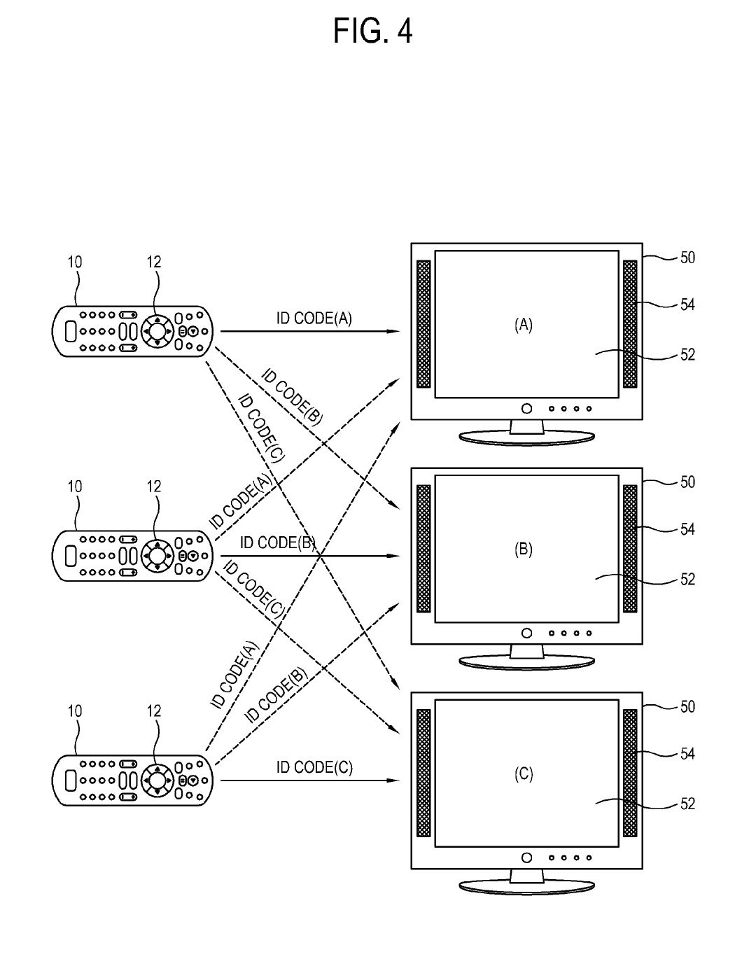

Referring to FIGS. 3 and 4, the control signal 30 output from the remote controller 10 in this embodiment includes a 4-bit ID code 38. Here, the ID code is n-bit, the number of the ID code is 2n. The ID codes 38 are pared with 2n passive control devices 50 one-to-one. For example, a 1-bit ID code 38 generates the ID codes 38 to be pared with 21=2 passive control devices 50, respectively. In other words, the 1-bit ID code 38 means that the same kind of only two remote controllers 10 and two passive control devices 50 can be paired with each other.

In this embodiment, the 4-bit ID code 38 generates 16 ID codes 38 to be pared with 24=16 passive control devices 50, respectively. Thus, the number of remote controllers 10 and passive control devices 50 to be paired one to one in the same kind of electronic apparatuses 1 increases as n becomes higher.

For example, as shown in FIG. 3, if there are three electronic apparatuses 1, the remote controller 10 generates the ID codes (A), (B) and (C) 38 corresponding to the passive control devices (A), (B) and (C) 50.

The passive control device 50 includes a display unit 52, a sound output unit 54, a code generator 56, a storage unit 58 and a controller 60. In this embodiment, a video device is described as an example of the passive control device 50, but not limited thereto. Alternatively, the passive control device 50 may include various devices such as an audiovisual (AV) system.

The display unit 52 outputs a video signal or displays a control ID code under control of the controller 60 to be described later. Further, the sound output unit 54 outputs an audio signal, or outputs a control ID code as a sound under the control of the controller 60. Further, the display unit 52 and the sound output unit 54 will be described in detail together with description of the controller 60.

The code generator 56 generates a control ID code corresponding to the ID code 38 based on the control signal 30 from the remote controller 10. That is, the code generator 56 serves to generate the control ID code corresponding to the ID code 38 so that the remote controller 10 can be pared with the passive control device 50 one to one. The storage unit 58 stores the control ID code generated by the code generator 56.

The controller 60 receives the control signal 30 from the remote controller 10 and controls the code generator 56 to generate the control ID code corresponding to the ID code 38 involved in the control signal 30. That is, the controller 60 controls the code generator 56 to set up the control ID code corresponding to the ID code 38, thereby generating the control ID code.

Further, the controller 60 controls the display unit 52 to display the control ID code or the sound output unit 54 to output the control ID code as a sound when the control ID code is generated and stored. The controller 60 controls the display unit 52 to display an on screen display (OSD) menu or the sound output unit 54 to output a sound, thereby informing a user that the control ID code is set up corresponding to the ID code 38. Here, the control ID code output as the OSD menu on the display unit 52 may be accomplished by a combination of various characters like ‘SET 001’ or ‘SET 002.’ On the other hand, the control ID code output as a sound may be achieved by a beep sound or a previously stored voice.

If the control signal 30 is received from the remote controller 10 after storing the control ID code in the storage unit 58, the controller 60 compares the ID code 38 with the control ID code stored in the storage unit 58 and controls the operation of the passive control device 50 according to the data code 36 when the control code 38 is matched with the control ID code. For example, the controller 60 compares the ID code 38 and the stored control ID code when receiving the data code 36 for channel-up and the ID code 38, and controls the passive control device 50 to perform the channel-up if the ID code 38 is matched with the stored control ID code.

On the other hand, if the control signal 30 is received from the remote controller 10 after storing the control ID code in the storage unit 58, the controller 60 compares the ID code 38 with the control ID code stored in the storage unit 58 and controls the passive control device 50 not to operate corresponding to the data code 36 when the control code 38 is not matched with the control ID code. Further, if the passive control device 50 does not operate based on the data code 36, the controller 60 controls the display unit 52 to display the control ID code or the sound output unit 54 to output the control ID code as a sound, thereby informing a user that the remote controller 10 is not paired with the passive control device 50.

As shown in FIG. 4, the electronic apparatuses 1 are remotely controlled as follows according to whether the ID code 38 and the control ID code are matched or not matched. The control signal 30 having the additional ID code (A) 38 from the remote controller 10 applies the data code 36 not to the passive control devices (B) and (C) respectively corresponding to the ID codes (B) and (C) 38 but only to the passive control device (A) 50. Likewise, the control signal 30 having the additional ID code (B) 38 from the remote controller 10 applies the data code 36 only to the passive control device (B) 50, and the control signal 30 having the additional ID code (C) 38 from the remote controller 10 applies the data code 36 only to the passive control device (C) 50. Consequently, only the paired electronic apparatus 1 is remotely controlled, but others are not remotely controlled, thereby preventing a control error.

The controller 60 releases a setting of the control ID code when the passive control device 50 is turned off. That is, when the passive control device 50 is turned off, the controller 60 deletes the control ID code stored in the storage unit 58. Such control of the controller 60 may be available when the remote controller 10 is replaced or the like.

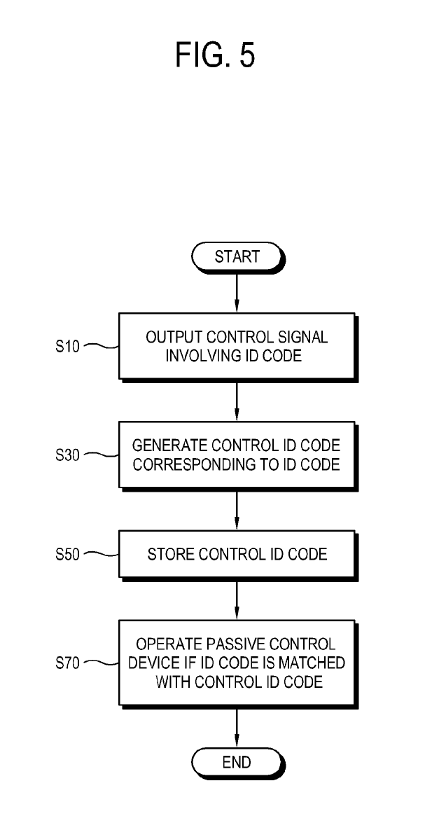

Below, a remote control method of the electronic apparatus 1 with this configuration according to an exemplary embodiment of the present invention will be described with reference to FIG. 5.

First, at operation S10, the remote controller 10 generates the ID code 38 to be paired with the passive control device 50 one to one, and transmits the control signal 30 involving the generated ID code 38 to the passive control device 50.

At operation S30, the passive control device 50 receives the control signal 30 involving the ID code 38 and generates the control ID code corresponding to the ID code 38. At operation S50, the generated control ID code is stored in the storage unit 58. Then, the remote controller 10 and the passive control device 50 are paired with each other.

After the remote controller 10 and the passive control device 50 are paired with each other one to one, at operation S70 the remote controller 10 outputs the control signal 30 and the passive control device 50 compares the received ID code 38 with the stored control ID code and operates based on the data code 36 involved in the control signal 30 if the received ID code 38 is matched with the stored control ID code.

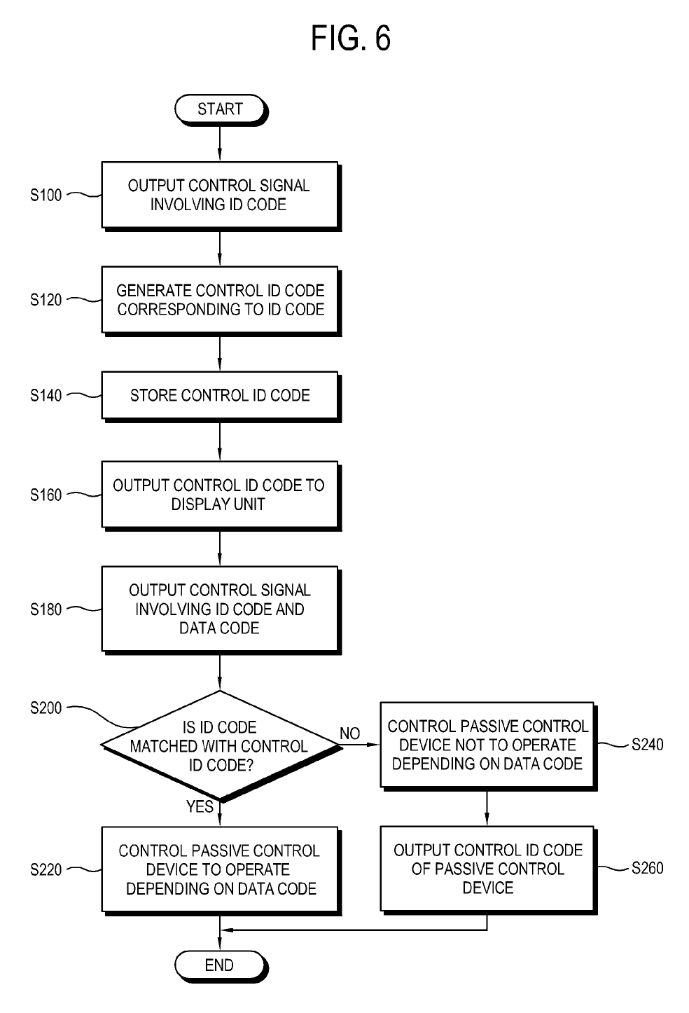

In the meantime, as shown in FIG. 6, a remote control method of the electronic apparatus 1 according to a first exemplary embodiment of the present invention including the display unit 52 is as follows.

First, at operation S100 the control signal 30 involving the ID code 38 is output. At this time, the ID code 38 may be changed by a combination of the input buttons 12 in the operation S100 of outputting the control signal 30.

At operation S120, the passive control device 50 receives the control signal 30 from the remote controller 10 and generates the control ID code corresponding to the ID code 38 involved in the control signal 30. At operation S140, the generated control ID code is stored in the storage unit 58 of the passive control device 50. At operation S160, the control ID code is displayed on the display unit 52, thereby informing a user that the remote controller 10 and the passive control device 50 are paired with each other one to one.

At operation S180, the remote controller 10 outputs the control signal 30 to operate the passive control device 50. Here, the control signal 30 involves the data code 36 for operating the passive control device 50. At operation S200, the passive control device 50 compares the ID code 38 with the control ID code stored in the storage unit 58.

If the ID code 38 is matched with the control ID code, at operation S220 the passive control device 50 operates corresponding to the data code 36.

On the other hand, if the ID code 38 is not matched with the control ID code, at operation S240 the passive control device 50 is not operated by the data code 36. Then, at operation S260, the control ID code of the passive control device 50 is displayed on the display unit 52, so that a user can be informed that the remote controller 10 and the passive control device 50 are not paired.

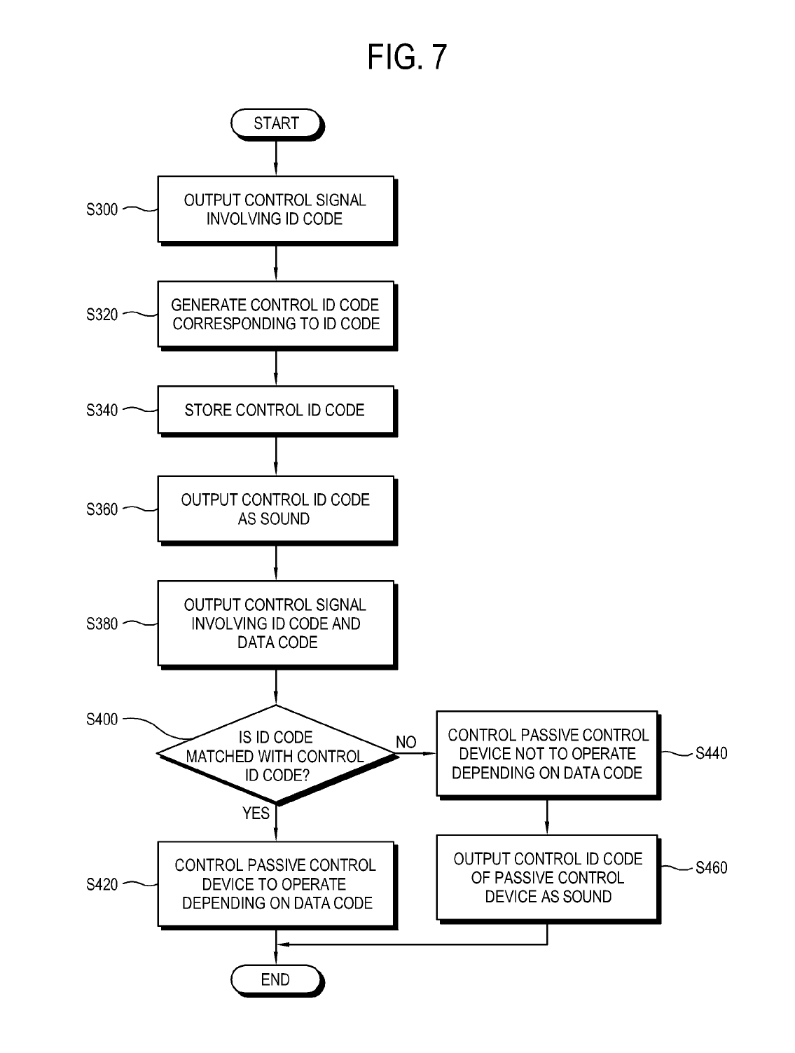

As shown in FIG. 7, a remote control method of the electronic apparatus 1 according to a second exemplary embodiment of the present invention including the sound output unit 54 is as follows.

First, at operation S300 the control signal 30 involving the ID code 38 is output. At this time, the ID code 38 may be changed by a combination of the input buttons 12 in the operation S100 of outputting the control signal 30.

At operation S320, the passive control device 50 receives the control signal 30 from the remote controller 10 and generates the control ID code corresponding to the ID code 38 involved in the control signal 30. At operation S340, the generated control ID code is stored in the storage unit 58 of the passive control device 50. At operation S360, the generated control ID code is output as a sound through the sound output unit 54, thereby informing a user that the remote controller 10 and the passive control device 50 are paired with each other one to one.

At operation S380, the remote controller 10 outputs the control signal 30 to operate the passive control device 50. Here, the control signal 30 involves the data code 36 for operating the passive control device 50. At operation S400, the passive control device 50 compares the ID code 38 with the control ID code stored in the storage unit 58.

If the ID code 38 is matched with the control ID code, at operation S420 the passive control device 50 operates corresponding to the data code 36.

On the other hand, if the ID code 38 is not matched with the control ID code, at operation S440 the passive control device 50 is not operated by the data code 36. Then, at operation S460, the control ID code of the passive control device 50 is output through the sound output unit 54, so that a user can be informed that the remote controller 10 and the passive control device 50 are not paired.

Thus, the remote controller and the passive control device are paired with each other one to one, so that other devices than that paired with the remote controller can be prevented from being controlled, thereby improving reliability of a product.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A remote control method of an electronic apparatus having a passive control device and a remote controller remotely controlling the passive control device, the remote control method comprising:
outputting from the remote controller a control signal including an identification (ID) code and a data code;
storing in the passive control device a control ID code corresponding to the ID code;
comparing the ID code with the control ID code to determine if the ID code is matched with the control ID code; and
controlling the passive control device to operate based on the data code if the ID code is matched with the control ID code.

2. The remote control method according to claim 1, wherein the ID code is user selectable.

3. The remote control method according to claim 2, wherein the ID code comprises an n-bit signal.

4. The remote control method according to claim 1, further comprising outputting the control ID code from the passive control.

5. The remote control method according to claim 4, wherein the passive control device comprises a display unit, and the control ID code is displayed on the display unit.

6. The remote control method according to claim 4, wherein the passive control device comprises a sound output unit, and the control ID code is output through the sound output unit.

7. The remote control method according to claim 1, further comprising controlling the passive control device not to operate based on the data code if the ID code is not matched with the control ID code.

8. The remote control method according to claim 2, further comprising controlling the passive control device not to operate based on the data code if the ID code is not matched with the control ID code.

9. The remote control method according to claim 5, further comprising informing a user of the control ID code stored in the passive control device if the ID code is not matched with the control ID code.

10. The remote control method according to claim 6, further comprising informing a user of the control ID code stored in the passive control device if the ID code is not matched with the control ID code.

11. The remote control method according to claim 1, further comprising releasing a setting of the control ID code if the passive control device is turned off.

12. An electronic apparatus comprising:
a remote controller which includes an identification (ID) code generator to generate an ID code and outputs a control signal including the ID code and a data code; and
a passive control device which includes a code generator, a storage unit and a controller,
wherein the code generator generates a control ID code corresponding to the ID code,
wherein the storage unit stores the control ID code, and
wherein the controller compares the ID code with the control ID code stored in the storage unit and controls the passive control device to operate based on the data code if the ID code is matched with the control ID code.

13. The electronic apparatus according to claim 12, wherein the remote controller comprises a plurality of input buttons, and the ID code generator generates the ID code based on a combination of the plurality of input buttons.

14. The electronic apparatus according to claim 12, wherein the passive control device further comprises a display unit, and wherein the controller controls the display unit so that the control ID code can be displayed in the passive control device.

15. The electronic apparatus according to claim 12, wherein the passive control device further comprises a sound output unit, and wherein the controller controls the sound output unit so that the control ID code can be output in the passive control device.

16. The electronic apparatus according to claim 12, wherein the controller compares the ID code with the control ID code stored in the storage unit and controls the passive control device not to operate based on the data code if the ID code is not matched with the control ID code.

17. The electronic apparatus according to claim 13, wherein the controller compares the ID code with the control ID code stored in the storage unit and controls the passive control device not to operate based on the data code if the ID code is not matched with the control ID code.

18. The electronic apparatus according to claim 14, wherein the controller compares the ID code with the control ID code stored in the storage unit and controls the display unit to display the control ID code stored in the passive control device if the ID code is not matched with the control ID code.

19. The electronic apparatus according to claim 15, wherein the controller compares the ID code with the control ID code stored in the storage unit and controls the sound output unit to output the control ID code stored in the passive control device if the ID code is not matched with the control ID code.
